(19) United States
(12) Patent Application Publication
(10) Pub. No.: US 2020/0211124 A1
(43) Pub. Date: Jul. 2, 2020

(54) METHODS AND SYSTEMS FOR USE IN PROVIDING ACCOUNT SERVICES

(71) Applicant: MASTERCARD INTERNATIONAL INCORPORATED, PURCHASE, NY (US)

(72) Inventors: Deepankar Bhagat, Chesterfield, MO (US); Matt Wickman, O'Fallon, MO (US)

(21) Appl. No.: 16/236,830

(22) Filed: Dec. 31, 2018

(51) Int. Cl. G06Q 50/00; G06Q 20/24; G06Q 20/40; G06Q 20/34

(52) U.S. Cl. CPC G06Q 50/01; G06Q 20/24; H04W 4/21; G06Q 20/351; G06Q 20/4016

(57) ABSTRACT

Systems and methods herein provide limited credit accounts from social networks to recipient users having social network accounts at the social networks, in response to network requests by sender users to transfer funds to the recipient users through the social networks. One exemplary method includes receiving a request to transfer an amount of funds from a sender user to a recipient user, where the sender user and the recipient user both have social network accounts at a social network, and generating a score for the fund transfer based on at least a transaction history associated with the sender user. The method also includes determining whether the score satisfies a threshold and, when the score satisfies the threshold, generating a virtual card number (VCN) for the recipient user, wherein the VCN is associated with a credit line based on the amount of funds included in the request.

### FIELD

The present disclosure generally relates to methods and systems for use in providing account services to users, and in particular, to methods and systems for use in providing accounts from networks to individual recipient users associated with the networks, in response to network requests from sender users to the recipient users and based on one or more scores associated with the sender users and/or recipient users.

### BACKGROUND

This section provides background information related to the present disclosure which is not necessarily prior art.

People are known to interact with other people through social networks. Often, such interaction within the social networks includes the sharing of comments, information, or other content related to one or more topics of conversation, or based on a relation between the people involved in the interaction (e.g., friends, family, coworkers, etc.). And, in so doing, the topics of conversation may include, without limitation, different subjects relating to personal interests, careers, activities, relationships, etc. In addition, certain social networks permit people to transfer funds to other people within the social networks. For example, the Facebook® social network includes a money send option within a message feature, which may be selected by users of the social network to transfer money. In particular, the money send option requires a sender user to add a valid existing payment account or payment card to the sender user's profiler within the social network (to fund the money transfer), and also a recipient user to add a valid existing payment account or payment card to the recipient user's profile within the social network (to receive the money), whereby each of the users is associated with an existing account at the social network and an already existing financial account associated with their profile at the social network to send/receive the money/funds between their added accounts/cards.

### DRAWINGS

The drawings described herein are for illustrative purposes only of selected embodiments and not all possible implementations, and are not intended to limit the scope of the present disclosure.

FIG. 1 is an exemplary system of the present disclosure operable to provide accounts from networks to recipient users, in response to network requests by sender users directed to the recipient users;

FIG. 2 is a block diagram of an exemplary computing device that may be used in the system of FIG. 1; and

FIG. 3 is an exemplary method, which may be used with the system of FIG. 1, for providing an account from a network to a recipient user, in response to a network request by a sender user directed to the recipient user.

Corresponding reference numerals indicate corresponding parts throughout the several views of the drawings.

### DETAILED DESCRIPTION

Example embodiments will now be described more fully with reference to the accompanying drawings.

Social networks permit users to interact with other users. In addition, social networks permit the transfer of funds between users, when existing payment accounts associated with the users (e.g., wallet accounts, etc.) are linked by the users to the social networks (e.g., to the users' accounts at the social networks, etc.). However, when the users' payment accounts are not linked to accounts of the social networks, or the users do not have such accounts, fund transfers within the social networks may not be possible. Uniquely, the systems and methods herein provide specific accounts, issued by the social networks, for users to send and receive funds within the social networks (e.g., when the users do not initially have such accounts, etc.) (e.g., for the social networks to extend microcredit to the users, etc.). In particular, a social network may partner with an account issuer or with a payment network, which then issues a line of credit to the social network. The social network, in turn, may then issue limited credit accounts to users associated with the social network (via the line of credit), based on certain scoring related to the users and/or determined by the issuer/payment network providing the line of credit to the social network (e.g., scores derived by combining trust scores for the users and scores provided by the issuer/payment network, etc.), for use by the social network in transferring and/or receiving funds to/from the users. In this manner, sender users and recipient users are able to send and receive funds from and to payment accounts within the social network (without the users necessarily providing existing payment accounts or cards to the social network), and the social network is permitted to host fund transfers for such funds based on the line of credent extended thereto by the issuer/payment network (in a manner not previously available).

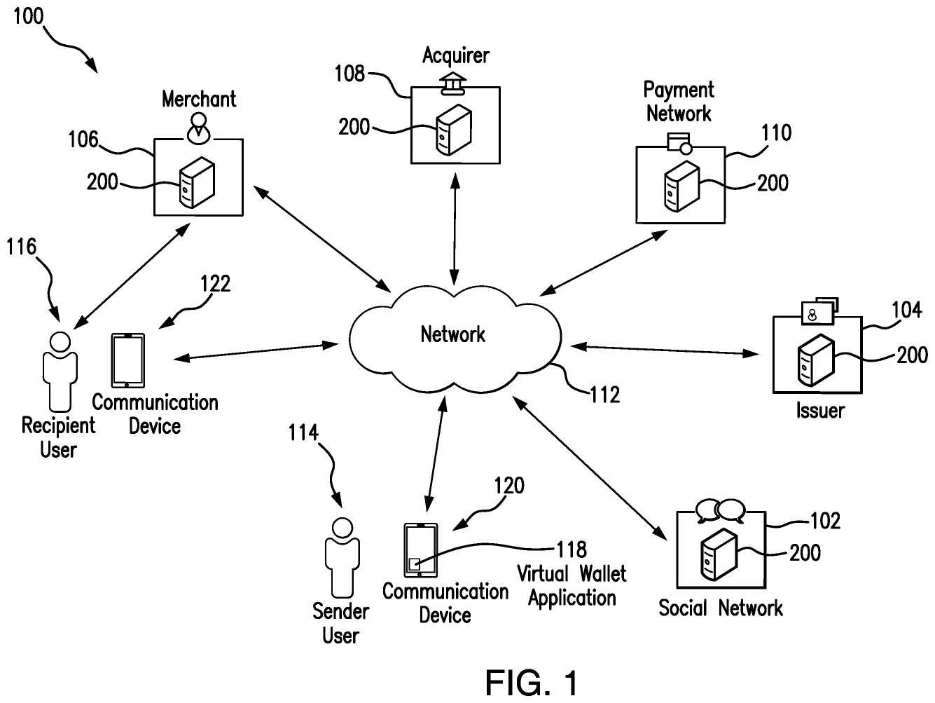

FIG. 1 illustrates an exemplary system 100 in which one or more aspects of the present disclosure may be implemented. Although the system 100 is presented in one arrangement, other embodiments may include systems arranged otherwise, depending, for example, on social networks involved therein, on fund transfer requirements, on account restrictions, etc.

The illustrated system 100 generally includes a social network 102, an issuer 104 (e.g., and issuer banking institution, etc.) configured to issue financial accounts to users (e.g., payment accounts, savings accounts, other accounts, etc.), a merchant 106, an acquirer 108 associated with the merchant 106 and one or more financial accounts of the merchant 106, and a payment network 110, each of which is coupled to (and is in communication with) network 112. The network 112 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, the network 112 may include multiple different networks, such as a private payment transaction network made accessible by the payment network 106 to the acquirer 108 and the issuer 108 and, separately, the public Internet, which is accessible as desired to the social network 102, the issuer 104, the merchant 106, and the acquirer 108, etc.

The social network 102 of the system 100 is configured to provide a platform through which users (e.g., users 114 and 116, etc.) are able to communicate with one another specifically, or generally, and/or to post, share or contribute content, etc. as desired. As such, each of the users 114 and 116 is associated with a social network account at the social network 102. The social network accounts include details about the respective users 114 and 116, such as, for example, their names, email addresses, mailing addresses, usernames, passwords, and/or other suitable data associated with the users 114 and 116 and relevant to the social network 102, etc. With that said, in use of the social network 102, the user 114, for example, may access his/her social network account at a network-based application or website associated with the social network 102, whereby the user 114 is permitted to view content or provided content to the social network 102 (e.g., post comments or images, etc.), etc. The user 116 may similarly interact with the social network 102. As the users 114 and 116 interact with the social network 102, a social network history for the users 114 and 116 is created and stored in memory associated with and/or included in the social network 102.

It should be appreciated that the social network 102 may include any example social network including, for example, Facebook®, Twitter®, Google+®, Flickr®, Instagram®, LinkedIn®, Myspace®, Pinterest®, etc. In connection therewith, the social network 102 may be limited primarily to social features, or may include social features integrated with other features (e.g., reviews, shopping, dating, etc.). Notwithstanding the specific examples herein, it should be appreciated that any social network, which provides sharing of social content/information among users based on similar personal or career interests, activities, backgrounds, or real-life connections, etc., may be employed herein, or in other system embodiments.

The issuer 104 in the system 100 includes, generally, an institution (e.g., a banking institution, etc.) that issues accounts to users and entities, and which are then used to transfer funds, hold funds, initiate purchase transactions, etc. In connection therewith, the issuer 104 is configured to issue a financial account to each of the users 114 and 116. The financial account may be a payment account, which may include, without limitation, a credit account, a debit account, etc. And, the payment accounts may then be usable, by the users 114 and 116, to fund transactions for the purchase of products from the merchant 108, for example (and which are processed via the merchant 106, the acquirer 108, the payment network 110, and the issuer 104 in a conventional manner four-party manner, etc.), or to transfer funds to other users, etc.

Also in this exemplary embodiment, the issuer 104 is configured to issue a financial account to the social network 102. The account is a credit account and includes a line of credit that is sufficient to be used by the social network 102 to accommodate the operations described herein. In particular, the credit account is provided by the issuer 104 in connection with an agreement with the social network 102 that the account is for use in operations described herein with respect to users 114 and 116 (and any other users) and fund transfers via the social network 102, and is not for general use by the social network 102. As such, the credit account is generally provided as a source of credit to be extended to the users 114 and 116 (and any other users of the social network 102 (e.g., other users also having social network accounts with the social network 102, etc.)), as described herein. That said, any type of account may be issued by the issuer 104 to the social network 102 and/or used by the social network 102 to extend credit to users, whether limited to that purpose or not.

The merchant 106 in the system 100 is configured to offer for sale and to sell products to consumers including, for example, to the users 114 and 116, shown in FIG. 1. The merchant 106 may be disposed and/or accessible at one or more physical locations, for example, at one or more brick-and-mortar locations, and/or at one or more virtual locations, for example, via one or more network-based applications (e.g., a website, etc.). In connection therewith, the acquirer 108 is associated with the merchant 106, in that the acquirer 108 is a banking institution, etc. that has issued one or more financial accounts to the merchant 106. The one or more financial accounts may include accounts operating as receptacles for funds transferred to the merchant 106 in connection with payment account transactions for the purchase of product(s), etc.

And, the payment network 110 in the system 100 (e.g., Mastercard®, VISA®, Discover®, American Express®, etc.) is provided generally between the acquirer 108 and the issuer 104 to facilitate payment account transactions between users and merchants, etc. (e.g., in a conventional four-party manner, etc.). In addition herein, the payment network 110 is configured as a wallet platform. In this manner, the payment network 110 is configured to provision payment account credentials to the user 114, for example, at a virtual wallet application 118 at a communication device 120 associated with the user 114 and/or to facilitate payment account transactions to a payment account appended to the user's wallet application 118. Further, as shown in FIG. 1, the user 116 is also associated with a communication device 122. In connection therewith, the communication devices 120 and 122 may each include, for example, a smartphone, a laptop, a tablet, etc. Often, though, the communication devices 120 and 122 will each include a portable communication device, so that the communication devices 120 and 122 are located with and/or are carried with the consumers 114 and 116, for use as described herein. As described, the communication device 120 associated with the user 114 includes the virtual wallet application 118, which configures the communication device 120 to operate, in conjunction with the payment network 110, as a payment device for use by the user 114. And, while not illustrated, it should be appreciated that the user 116 may similarly be associated with a virtual wallet application at his/her communication device 122. What's more, it should also be appreciated that the payment network 110 may also be configured to provide a financial account to the social network 102, in a similar manner to the issuer 104, in one or more embodiments of the present disclosure.

In the system 100, the social network accounts of the users 114 and 116 also permit each of the users 114 and 116 to add a payment account to his/her social network account, as desired, whereby the payment account may be used to fund product purchases and/or fund transfers between the user 114, or the user 116, or another user of the social network 102. For example, in the illustrated system 100, the user 114 has added the payment account issued to the user 114 by the issuer 104 to his/her social network account, either directly or through the virtual wallet application 118. The use of the payment account by the user 114, then, as linked through the social network 102, is described in more detail below. The user 116, however, has not added his/her payment account to his/her social network account at the social network 102 and, as such, does not have a financial account linked to his/her social network account.

While only one social network 102, one issuer 104, one merchant 106, one acquirer 108, and one payment network 110 are illustrated in FIG. 1, it should be appreciated that any number of these entities (and their associated components) may be included in the system 100, or may be included as a part of systems in other embodiments, consistent with the present disclosure. Similarly, while only two users 114 and 116 are illustrated in FIG. 1, it should be appreciated that more users (and, often, tens, hundreds, thousands, etc. of users) may be included in the system 100 in other system embodiments.

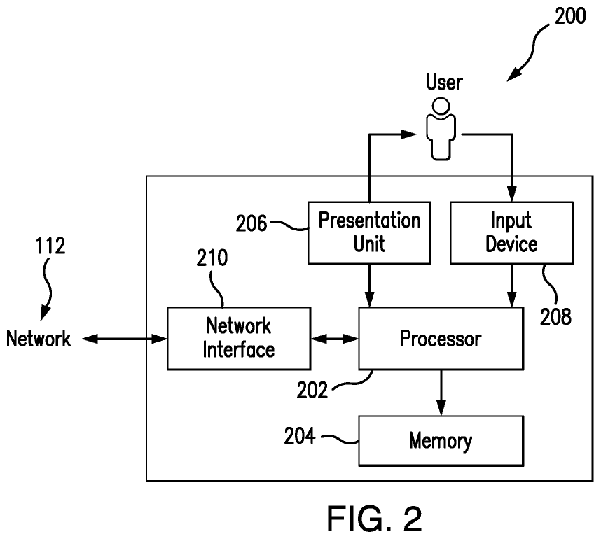

FIG. 2 illustrates an exemplary computing device 200 that can be used in the system 100. The computing device 200 may include, for example, one or more servers, workstations, personal computers, laptops, tablets, smartphones, terminals, etc. In addition, the computing device 200 may include a single computing device, or it may include multiple computing devices located in close proximity or distributed over a geographic region, so long as the computing devices are specifically configured to function as described herein. In the system 100 of FIG. 1, each of the social network 102, the issuer 104, the merchant 106, the acquirer 108, and the payment network 110 are illustrated as including, or being implemented in, a computing device 200 coupled to (and in communication with) the network 112 (to provide communication therebetween). In addition, the communication devices 120 and 122 should also be understood to be consistent with the computing device 200, and may be coupled to (and in communication with) the network 112. That said, however, the system 100, or parts thereof, should not be understood to be limited to the computing device 200, as other computing devices may be employed in other system embodiments. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable storage media. The memory 204 may be configured to store, without limitation, transaction data, social network data, payment account credentials, virtual card numbers (VCNs), scores, and/or other types of data (and/or data structures) as needed and/or suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein. It should be appreciated that the memory 204 may include a variety of different memories, each implemented in one or more of the operations or processes described herein.

In the exemplary embodiment, the computing device 200 includes a presentation unit 206 that is coupled to (and that is in communication with) the processor 202 (however, it should be appreciated that the computing device 200 could include output devices other than the presentation unit 206, etc. in other embodiments). The presentation unit 206 outputs information (e.g., options to transfer funds, account balances, available credit, etc.), either visually or audibly, to a user of the computing device 200, for example, the user 114 in the system 100, etc. Various interfaces (e.g., as defined by network-based applications, etc.) may be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, another computing device, etc. In some embodiments, presentation unit 206 may include multiple devices.

The computing device 200 also includes an input device 208 that receives inputs from the user (i.e., user inputs) such as, for example, selections to transfer funds, or inputs from other computing devices. The input device 208 is coupled to (and is in communication with) the processor 202 and may include, for example, a keyboard, a pointing device, a mouse, a touch sensitive panel (e.g., a touch pad or a touch screen, etc.), another computing device, and/or an audio input device. Further, in various exemplary embodiments, a touch screen, such as that included in a tablet, a smartphone, or similar device, may behave as both the presentation unit 206 and the input device 208.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter (e.g., an NFC adapter, a Bluetooth adapter, etc.), or other device capable of communicating to/with one or more different networks, including the network 112. In some exemplary embodiments, the computing device 200 may include the processor 202 and one or more network interfaces incorporated into or with the processor 202.

Referring again to FIG. 1, as described above, the users 114 and 116 in the system 100 are associated with financial accounts issued by the issuer 104. Upon issuance, and thereafter, the users 114 and 116 use the payment accounts to purchase products, transfer funds, etc., over a period of time, such as, for example, a week, a month, a year, etc. In this manner, the user 114, for example, is associated, through his/her payment account, with a transaction history, including prior (or pending) purchases, transfers, refunds, etc. (broadly, transactions). Likewise, the user 116 is associated, through his/her payment account, with a transaction history including prior (or pending) purchases, transfers, refunds, etc. The transaction histories, then, are represented by transaction data for the users 114 and 116, which includes, without limitation, times/dates for the transactions, merchants involved in the transactions, recipients of funds for the transactions, amounts of the transactions, etc. The transaction histories are stored, by the issuer 104 and/or the payment network 110, in a database or data structure (e.g., in memory 204 of the computing device 200 associated therewith, etc.), and maintained as accessible to at least the issuer 104 and/or the payment network 110.

In addition, the user 114 also engages in transactions (e.g., purchases, fund transfers, etc.) with one or more users in the social network 102 (e.g., the user 116, etc.). To do so, the user 114 uses the payment account issued by the issuer 104 and which is added to (or linked to) the social network account of the user 114 (as described above). In this manner, the social network 102 is also configured to store (e.g., in memory 204 of the computing device 200 associated therewith, etc.) a transaction history of the user 114 (for transactions involving the user 114 and one or more other users of the social network 102, etc.). The user's social network transaction history will generally be included in the user's overall transaction history, but is limited, generally, to transactions facilitated and/or initiated through the social network 102. The social network transaction history, then, is also maintained by the social network 102 and is also accessible to at least the social network 102.

Subsequently in the system 100, the users 114 and 116 interact through the social network 102, for example, through posts to a website, while signed into their respective social network accounts. At some point, the user 114 (i.e., as a sender user) decides to transfer funds to the user 116 (i.e., as a recipient user) through the social network 102. In connection therewith, the social network 102 is configured to provide a fund transfer option, which is selected by the user 114 (e.g., as a link at the social network 102, etc.). In turn, the social network 102 is configured to solicit fund transfer parameters from the user 114 (via one or more interfaces), including, for example, a name or username (or other identifier) of the user 116 to whom funds are to be transferred, an amount of funds to be transferred, an indication of the account to be used to fund the transfer, etc. And, the user 114 responds to the social network 102 with the solicited parameters.

In response to the request by the user 114 to transfer the funds to the user 116, or prior thereto, the social network 102 is configured to generate a sub-score for the user 114 based on his/her transaction history known to the social network 102 (e.g., the user's social network transaction history (e.g., a total number of transfer transactions performed by the user 114 through the social network 102; a number of transfer transactions performed by the user 114 each week, month, year, etc.; a total number of transfer transactions performed by the user 114 specifically with the user 116; a number of transfer transactions performed by the user 114 with the user 116 per week, month, year, etc.; etc.), and/or based on a social graph available to the social network 102 and associated with the user 114, etc. (e.g., on a scale of 1-25, etc.). In addition, the social network 102 is configured to generate a sub-score for the user 116 (e.g., on a scale of 1-25, etc.). In this example, the user 116 does not have a payment account at the social network 102 associated with his/her social network account. As such, the social network 112 is configured to generate the sub-score for the user 116 based on available interactions of the user 116 with at least the user 114 (e.g., a quantity of such interactions, a content of such interactions, etc.) (e.g., taking into account a social graph for the user 116 at the social network 102, etc.), and age of the account at the social network 102 for the user 114 (e.g., a length of time the user has had his/her account at the social network 102, etc.), and activity level of the account for the user 114 (e.g., a number of times the user 114 makes use of his/her account each day, week, month, etc.), etc. The social network 102 may be configured to utilize similar information and available interactions of the user 114 with at least the user 116 in generating the sub-score for the user 114. Further, in some embodiments, the social network 102 may be configured to generate the sub-scores for the users 114 and/or 116 based, at least in part, on a geographical distance between the users 114 and 116 (e.g., a geographical distance between residences, between last identified addresses/locations in social media interactions, etc.).

In one or more embodiments, the social network 102 may further be configured to request a risk (or trust) score from the issuer 104 and/or the payment network 110, for one or both of the users 114 and 116 (e.g., through an API call, etc.). The issuer 104 and/or the payment network 110 may be configured, in turn, to then generate a risk score for the users 114 and/or 116 based on the transaction history associated therewith (and available to the issuer 104 and/or the payment network 110) (e.g., based on one or more decision intelligence products such as those utilized/provided by Mastercard International Incorporated, etc.). For instance, the risk scores for the users 114 and 116 (as generated by the issuer 104 and/or the payment network 110) may be based on whether or not the payment account of the user 114 (which is linked to the user's social network account) (and any payment device associated therewith) and/or a payment account of the user 116 have appeared in prior transactions processed by the issuer 104 and/or the payment network 110. If issuer 104 and/or the payment network 110 determine that both users 114 and 116 have facilitated transactions through the payment network 110, a low risk score may be assigned for each of the users 114 and 116 (e.g., a risk score of 1 on a scale of 1-25, etc.). Alternatively, if only the payment account for user 114 has appeared in prior transactions processed by the issuer 104 and/or the payment network 110, a low risk score may be assigned for the user 114 (e.g., a risk score of 1 on a scale of 1-25, etc.) and a high risk score may be assigned for the user 116 (e.g., a risk score of 25 on a scale of 1-25, etc.). In addition, the issuer 104 and/or the payment network 110 may similarly be configured to determine whether other data associated with the users 114 and 116 have appeared in prior transactions processed by the issuer 104 and/or the payment network 110, such as payment card numbers (e.g., for the user 114, etc.), shipping/billing addresses, etc. Further, in some embodiments, the issuer 104 and/or the payment network 110 may be configured to use additional factors such as the credit scores of the users 114 and 116, average spend by the users 114 and 116 to their respective accounts, a comparison of such average spend to the amount of the current transfer request, etc., at least in part, to generate the risk score(s). In any case, once generated, the issuer 104 and/or the payment network 110 is/are configured to provide the risk score(s) back to the social network 102.

Then in the system 100, the social network 102 is configured to combine the two sub-scores for the users 114 and 116 (as generated by the social network 102) and the risk scores for the users 114 and 116 provided by the issuer 104 and/or the payment network 110 (when generated/received) to determine a total score for the fund transfer/transaction. The total score may be a straight combination of the scores (e.g., an addition of all scores, an average of all scores, etc.), or it may involve weighting one or more of the scores prior to the combination. When the total score satisfies a threshold (e.g., where the total score is on a scale of 1-100, and the threshold is a value of 80; etc.), the social network 102 is configured to notify the user 116 of the pending transfer, who in turn selects to provide personal data (e.g., to be associated with a new social network financial account provided by the social network 102, etc.) now or later. When the user selects to provide the personal data now, the social network 102 is configured to provide a link for the user 116 to a banking institution, such as, for example, the issuer 104. When the link is selected, the user 116 is connected with the issuer 104, whereupon a registration process is completed for associating a new social network financial account for the user 116 with the user's account at the social network 102. Thereafter, the issuer 104 is configured to notify the social network 102 that the new financial account is created for the user 116 and linked to the user's social network account. With that said, it should be appreciated that in some embodiments the new social network financial account may be limited to use for transactions facilitated through the social network 102. However, in other embodiments, the social network financial account may be used by the user 116 to perform transactions facilitated through the social network 102 as well as other transactions independent of the social network 102 (e.g., purchase transactions directly at the merchant 106, etc.).

Upon receipt of the notice from the issuer 104 that the new financial account is created for the user 116, or when the user 116 opts to provide the personal data later (for creation of the new financial account), the social network 102 is configured to generate a virtual card number (VCN) for the user 116 (based on the registration). The VCN is provided with a credit limit equal to the amount of the transfer from the sender user 114. When generated, the line of credit, issued by the issuer 104 to the social network 102, is decreased by the amount of the credit extended to the user 116 via the VCN. The social network 102 is further configured to notify the user 116 of the VCN and the available funds/credit. The user 116 may then use the funds/credit to perform desired transactions, through use of the VCN. It should be appreciated that in various implementations of the system 100, the user 116 may be required to provide the personal data for creation of the new financial account in order to use the transferred funds. If the user 116 does not provide the required data, the transaction may be terminated (and an authorization reversal process initiated). However, in other implementations of the system 100, If the user 116 does not provide the required data, the user 116 may still be allowed access to the transferred funds through use of the VCN, but may not be able to use the given account in any further transactions at the social network 102 (at least until the user 116 provides the required data).

When the recipient user 116 opts to provide the personal data later, the social network 102 is configured to further provide a link to the issuer 104 (e.g., when notifying the user 116 of the VCN, etc.), through which the registration process may be accessed, and an instruction to complete the registration prior to a next transfer of funds to the VCN. When the link is selected, the user 116 is connected with the issuer 104, whereupon the registration process is completed (otherwise, the VCN may not be further used by the user 116 to transfer funds through the social network 102, etc.). Like above, the issuer 104 is configured to notify the social network 102, and the social network 102 is configured to notify the user 116 that the VCN is useable for transfers.

As appreciated from the above, different scores and sub-scores are used in the system to compile the final total score for the given transaction between the user 114 and the user 116. In connection therewith, the different scores and sub-scores are generated by different parts of the system 100. For example, the sub-scores for the users 114 and 116 are generated by the social network 102 and the risk scores for the users 114 and 116 are generated by the payment network 110 (and/or the issuer 104). The different scores and sub-scores, used to generate the ultimate total score for the given transaction, are thus independently generated by the social network 102 and the payment network 110 (and/or the issuer 104) based on the data sets available to each part of the system 100. The different scores and sub-scores then feed into the overall total/final score used to determine if the receiver user 116 should be extended the short term credit or not to allow for completing the transaction.

In various exemplary embodiments, consumers (e.g., the users 114 and 116, etc.) involved in the different transactions/interactions herein (whether via the social network 102 and/or the issuer 104 and/or the payment network 110, etc.) are prompted to agree to legal terms associated with the respective accounts (e.g., payment accounts, social network account, etc.), for example, during enrollment, upon installation of related applications, etc. In so doing, the consumers may voluntarily agree, for example, to allow certain entities to collect data associated with the accounts and to use data collected during enrollment and/or collected in connection with use of the accounts, subsequently, at least for one or more of the different purposes described herein.

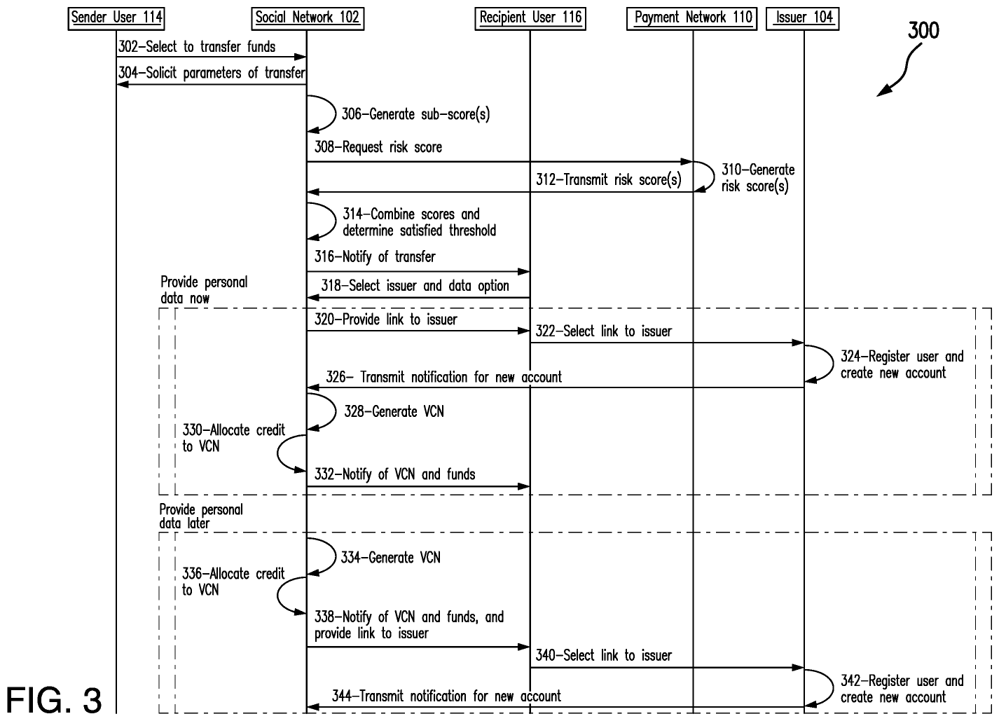

FIG. 3 illustrates an exemplary method 300, for use in providing financial accounts, by social networks, to recipient users in response to network requests to transfer funds. The exemplary method 300 is described as implemented in the social network 102 of the system 100, and with reference to the issuer 104, and also with reference to the computing device 200. The methods herein, however, should not be understood to be limited to the system 100 and/or the computing device 200. Likewise, the systems and devices herein should not be understood to be limited to the method 300.

Initially in the method 300, the user 114 (i.e., as the sender user) decides to transfer funds to the user 116 (i.e., as the recipient user) through the social network 102, at 302. For example, the social network 102 may provide a fund transfer option to the sender user 114, which is available to the user 114 (e.g., as a link at the social network 102, etc.) while the user 114 is logged into his/her social network account, and the user 114 may then select the fund transfer option (at 302) to initiate the transfer. In response, the social network 102 solicits, at 304, fund transfer parameters from the sender user 114 (via one or more interfaces), including, for example, a name or username (or other identifier) of the recipient user 116 to whom funds are to be transferred, an amount of funds to be transferred, and an indication and/or confirmation of the user's account from which the funds are to be removed (e.g., where the user 114 has multiple accounts linked to his/her social network account, etc.), etc. And, the sender user 114 responds to the social network 102 with the solicited parameters.

Next, and in response to the request by the sender user 114 to transfer funds to the recipient user 116, or prior thereto, the social network 102 generates, at 306, a sub-score for the user 114 based on his/her transaction history known and/or available to the social network 102 (e.g., the user's social network transaction history, etc.) (e.g., a number of transfer transactions by the user 114 through the social network 102; a number of transfer transactions by the user 114 each week, month, year, etc. through the social network 102; a number of transfer transactions by the user 114 with the user 116; a number of transfer transactions by the user 114 with the user 116 per week, month, year, etc.; a number of transfer transactions by the user 114 with other users through the social network 102 where a KYC process was omitted; etc.). In some embodiments, the sub-score for the user 114 may also be based on his/her social interactions via the social network 102 (e.g., taking into account a social graph involving the user 114 to evaluate a relationship between the user 114 and the user 116 and calculate the sub-score based at least in part on a proximity between the users 114 and 116 defined by the social graph (e.g., based on a number of connections between the user 114 and the user 116 represented in the social graph, a quantity of such interactions, a content of such interactions, an age of the account at the social network 102 for the user 114 (e.g., a length of time the user has had his/her account at the social network 102, etc.), an activity level of the account for the user 114 (e.g., a number of times the user 114 makes use of his/her account each day, week, month, etc.), etc.) taking into account social network analysis, etc.), etc. In connection therewith, in the method 300, the social network 102 also generates (at 306) a sub-score for the recipient user 116. In this example, the recipient user 116 does not have a payment account at the social network 102 associated with his/her social network account. As such, the social network 112 generates (at 306) the sub-score for the recipient user 116 based on interactions of the user 116 with at least the sender user 114 (e.g., a quantity of such interactions, a content of such interactions, etc.) (e.g., taking into account a social graph involving the user 116 to evaluate a relationship between the user 114 and the user 116 and calculate the sub-score based at least in part on a proximity between the users 114 and 116 defined by the social graph (e.g., based on a number of connections between the user 114 and the user 116 represented in the social graph, etc.) taking into account social network analysis, etc.), etc.).

The social network 102 then also requests, at 308, a risk score from the payment network 110, for both of the sender user 114 and the recipient user 116 (e.g., through an API call, etc.). In response, the payment network 110 generates, at 310, a risk score for each of the users 114 and 116 based on the transaction history associated therewith (and available to the issuer 104, the payment network 110, etc.) (e.g., based on one or more decision intelligence products available to the payment network 110 such as provided by Mastercard International Incorporated, etc.). In doing so, the payment network 110 may take into account data for the users 114 and 116 included in prior transactions processed by the payment network (e.g., transactions involving one or more payment devices associated with each of the users 114 and 116 but issued by other financial/nonfinancial institutions, transactions involving addresses of the users 114 and 116, etc.). Additional factors that may be used in generating the risk score may include a region where the transaction is taking place, data relating to the payment account of the user 116, any risk the issuer 104 is willing to accept in order to acquire new customers, credit scores for the users 114 and 116, average spend by the users 114 and 116 to their respective accounts, a comparison of such average spend to the amount of the current transfer request, etc. Once generated, the payment network 110 transmits, at 312, the risk scores back to the social network 102.

Upon receipt of the risk scores from the payment network 110, the social network 102 combines, at 314, the risk scores with the sub-scores (generated at 306) to determine a single, total score for the fund transfer and compares the total score to a threshold. When the total score satisfies the threshold, the social network 102 transmits, at 316, a notification to the recipient user 116 of the pending transfer together with a request for the user 116 to provide personal data to facilitate the transfer, either now or later (e.g., to be associated with a new social network financial account provided by the social network 102 and as part of a know-your-customer (KYC) process by the social network 102 and/or issuer 104 for the new financial account, etc.). In turn, the recipient user 116 selects, at 318, the desired option (e.g., issuer and/or KYC option, etc.) (to either provide the personal data now or later).

When the recipient user 116 selects to provide the personal data now (or when required based on the KYC process and/or an amount of funds being transferred, etc.), the social network 102 provides, at 320, a link to the user 116 for directing the user 116 to the issuer 104 (whereby the issuer 106 collects the necessary personal data from the user 116). And, at 322, the recipient user 116 selects the link, whereby the user 116 is connected with the issuer 104 and a registration process is performed, at 324, for associating a new social network financial account for the user 116 with the user's account at the social network 102. The registration process may involve solicitation of various data from the recipient user 116, as well as confirmation of various account features and/or settings for the new financial account (e.g., as part the KYC process, etc.). Thereafter, the issuer 104 transmits, at 326, a notification to the social network 102 that the new financial account is created for the recipient user 116 and is linked to the user's social network account. In response, the social network 102 generates, at 328, a virtual card number (VCN) for the recipient user 116 (based on the registration) and allocates, at 330, credit to the VCN in the amount of the transfer from the sender user 114. The social network 102 then notifies, at 332, the recipient user 116 of the VCN and the available funds/credit, whereby the user 116 may then use the funds/credit to perform desired transactions, through use of the VCN (e.g., in association with his/her social network account (as a social network payment or fund-transfer transaction), separate from his/her social network account consistent with a traditional payment account transaction (such as at the merchant 106), etc.).

Alternatively, when the recipient user 116 selects (at 318) to provide the personal data later, the social network 102 delays or postpones registration of the user 116 with the issuer 104 and instead generates, at 334, the VCN for the user 116 and allocates, at 336, the credit to the VCN in the amount of the transfer of funds from the sender user 114. The social network 102 then notifies, at 338, the recipient user 116 of the VCN and the available funds/credit, whereby the user 116 may use the funds/credit to perform desired transactions, through use of the VCN. In addition (at 338), the social network 102 provides a link to the recipient user 116 to connect with the issuer 104, through which the registration process may then be accessed (and whereby the issuer 104 may collect the necessary personal data from the user 116 to complete the KYC process). And, at 340, the recipient user 116 selects the link, whereby the user 116 is connected with the issuer 104 and the registration process is performed, at 342, for associating the new social network financial account (associated with the VCN) for the user 116 with the user's account at the social network 102. Thereafter, the issuer 104 transmits, at 344, a notification to the social network 102 that the new financial account is created for the recipient user 116 and is linked to the user's social network account. In various embodiments, the user 116 may have a predefined time within which to select the link and complete the registration process. And, in such embodiments, when the user 116 does not complete the registration process within the allocated time (or does not select the issuer and/or the KYC option), the transaction is terminated (and an authorization reversal process initiates). In connection therewith, the user 114 may be notified of the failed registration and that the transaction has been terminated (whereby the desired funds are not transferred to the user 116).

In view of the above, microcredit may be extended by social networks to users thereof to allow the users to facilitate fund transfers through the social network, particularly where at least the recipient users do not have financial accounts linked to the social networks. By using the microcredit options, the social networks are able to accommodate the fund transfers (in generally small amounts) while also addressing KYC requirements and maintaining the KYC process for the transfers (e.g., by allowing recipient users to address such KYC requirements after the transferred funds are extended to the recipient users by the social networks via their lines of credit, etc.).

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving, at a computing device of a social network, a request to transfer an amount of funds from a sender user to a recipient user, the sender user associated with a first social network account at the social network and the recipient user associated with a second social network account at the social network, the first social network account linked to a payment account of the sender user; (b) generating a score for the fund transfer based on at least a transaction history associated with the sender user; (c) determining, by the computing device, whether the score satisfies a threshold; and (d) when the score satisfies the threshold, generating, by the computing device, a virtual card number (VCN) for the recipient user and issuing the VCN to the recipient user, wherein the VCN is associated with a credit line based on the amount of funds included in the request.

As will also be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving a request to transfer an amount of funds from a sender user to a recipient user through a social network, the sender user associated with a first social network account at the social network and the recipient user associated with a second social network account at the social network, the first social network account linked to a payment account of the sender user; (b) generating a social network score for the sender user based on at least one of a social network transaction history for the sender user and a social graph for the sender user; (c) generating a social network score for the recipient user based on a social graph for the sender user; (d) retrieving, from a payment network computing device, a risk score for the sender user and a risk score for the recipient user, the risk score for the sender user based on at least a transaction history for the sender user as identified by the payment network, and the risk score for the recipient user based on at least a transaction history for the recipient user as identified by the payment network; (e) generating a total score for the transfer of funds based on the social network scores for the sender user and the recipient user and the risk scores for the send user and the recipient user; and (f) when the total score satisfies a threshold, generate a virtual card number (VCN) for the recipient user and issue the VCN to the recipient user, whereby microcredit is provided by the social network to the recipient user based on the amount of funds included in the request.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature, element or layer is referred to as being “on,” “engaged to,” “connected to,” “coupled to,” “included with,” “associated with,” or “in communication with” another feature, element or layer, it may be directly on, engaged, connected, coupled, associated, or in communication with/to the other feature, element or layer, or intervening features, elements or layers may be present. In contrast, when feature, element or layer is referred to as being “directly on,” “directly engaged to,” “directly connected to,” “directly coupled to,” “directly associated with,” or “directly in communication with” another feature, element or layer, there may be no intervening features, elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. In addition, the term “at least one of” includes any and all combinations of one or more of the associated listed items, whereby the term “at least one of” is consistent with the term “and/or”.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

Although the terms first, second, third, etc. may be used herein to describe various elements and operations, these elements and operations should not be limited by these terms. These terms may be only used to distinguish one element or operation from another element or operation. Terms such as “first,” “second,” and other numerical terms when used herein do not imply a sequence or order unless clearly indicated by the context. Thus, a first element operation could be termed a second element or operation without departing from the teachings of the exemplary embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A non-transitory computer readable storage media comprising computer-executable instructions that, when executed by at least one processor of a social network to provide a limited credit account to a recipient user having a social network account at the social network, cause the at least one processor to:
receive a request to transfer an amount of funds from a sender user to a recipient user through a social network, the sender user associated with a first social network account at the social network and the recipient user associated with a second social network account at the social network, the first social network account linked to a payment account of the sender user;
generate a social network score for the sender user based on at least one of a social network transaction history for the sender user and a social graph for the sender user as associated with the first social network account;
generate a social network score for the recipient user based on a social graph for the recipient user as associated with the second social network account;
retrieve, from a payment network computing device, a risk score for the sender user and a risk score for the recipient user, the risk score for the sender user based on at least a transaction history for the sender user as identified by the payment network, and the risk score for the recipient user based on at least a transaction history for the recipient user as identified by the payment network;
generate a total score for the transfer of funds based on the social network scores for the sender user and the recipient user and the risk scores for the send user and the recipient user; and
when the total score satisfies a threshold, generate a virtual card number (VCN) for the recipient user and issue the VCN to the recipient user, whereby microcredit is provided by the social network to the recipient user in the form of the VCN for the amount of funds included in the request, based at least in part on the social network scores generated for the sender user and the recipient user and the first and second social network accounts.

2. The non-transitory computer readable storage media of claim 1, wherein the computer-executable instructions, when executed by the at least one processor, further cause the at least one processor to notify the recipient user of the request to transfer funds and solicit, from the recipient user, an issuer and/or a know-your-customer (KYC) option.

3. The non-transitory computer readable storage media of claim 2, wherein the computer-executable instructions, when executed by the at least one processor, further cause the at least one processor to terminate the transfer of the funds when the recipient user does not select the issuer and/or the KYC option.

4. The non-transitory computer readable storage media of claim 1, wherein the microcredit is associated with a credit line provided to the social network by an issuer banking institution.

5. The non-transitory computer readable storage media of claim 4, wherein the computer-executable instructions, when executed by the at least one processor, further cause the at least one processor to transmit a link associated with the issuer banking institution to the recipient user, whereby when the link is selected by the recipient user at a computing device associated with the recipient user, the recipient user is connected with the issuer banking institution to perform a registration process for a new account at the issuer banking institution associated with the microcredit.

6. The non-transitory computer readable storage media of claim 5, wherein the computer-executable instructions, when executed by the at least one processor, cause the at least one processor, in connection with transmitting the link associated with the issuer banking institution to the recipient user, to transmit the link to the recipient user prior to generating the VCN.

7. The non-transitory computer readable storage media of claim 4, wherein the computer-executable instructions, when executed by the at least one processor, further cause the at least one processor to allocate credit to the VCN from the credit line based on the amount of funds included in the request.

8. A computer-implemented method for use in providing limited credit accounts from social networks to recipient users having social network accounts at the social networks, in response to network requests by sender users to transfer funds to the recipient users through the social networks, the method comprising:
receiving, at a computing device of a social network, a request to transfer an amount of funds from a sender user to a recipient user, the sender user associated with a first social network account at the social network and the recipient user associated with a second social network account at the social network, the first social network account linked to a payment account of the sender user;
generating a score for the fund transfer based on at least a transaction history associated with the sender user;
determining, by the computing device, whether the score satisfies a threshold; and
when the score satisfies the threshold, generating, by the computing device, a virtual card number (VCN) for the recipient user and issuing the VCN to the recipient user, wherein the VCN is associated with a credit line based on the amount of funds included in the request and through which the social network extends microcredit to the recipient user for the amount of the funds.

9. The computer-implemented method of claim 8, further comprising allocating the credit line to the recipient user from a credit line associated with the social network.

10. The computer-implemented method of claim 9, wherein generating the score includes:
generating, by the computing device, a first sub-score for the recipient user;
generating, by the computing device, a second sub-score for the sender user based on the transaction history; and
combining the first and second sub-scores, by the computing device, into the score.

11. The computer-implemented method of claim 8, wherein generating the score includes requesting a risk score for the sender user from a payment network associated with an issuer of the payment account of the sender user.

12. The computer-implemented method of claim 11, wherein generating the score further includes requesting a risk score for the recipient user from the payment network, the risk score for the recipient user based on transaction data for the recipient user.

13. The computer-implemented method of claim 8, further comprising notifying the recipient user of the request to transfer funds and soliciting an issuer and/or a know-your-customer (KYC) option, prior to generating the VCN for the recipient user.

14. The computer-implemented method of claim 13, further comprising terminating the fund transfer when the recipient user does not select the issuer and/or the KYC option.

15. The computer-implemented method of claim 8, wherein the credit line is provided to the social network by an issuer banking institution; and
wherein the method further comprises transmitting a link associated with the issuer banking institution to the recipient user, whereby when the link is selected by the recipient user at a computing device associated with the recipient user, the recipient user is connected with the issuer banking institution to perform a registration process for a new account at the issuer banking institution.

16. The computer-implemented method of claim 15, wherein transmitting the link associated with the issuer banking institution to the recipient user includes transmitting the link to the recipient user prior to generating the VCN, whereby the registration process for the new account is performed prior to extending the microcredit to the recipient user.

17. The computer-implemented method of claim 8, wherein receiving the request to transfer the amount of funds from the sender user to the recipient user, includes receiving, at the computing device, the request from the first social network account associated with the user.
